(19) United States
(12) Patent Application Publication
(10) Pub. No.: US 2012/0130816 A1
(43) Pub. Date: May 24, 2012

(54) SEARCH SYSTEM, SEARCH METHOD, SEARCH PROGRAM AND RECORDING MEDIUM

(75) Inventor: Kazuya Sakamoto, Shinagawa-ku (JP)

(73) Assignee: RAKUTEN, INC., Shinagawa-ku, Tokyo (JP)

(21) Appl. No.: 13/387,919

(22) PCT Filed: Mar. 30, 2011
(86) PCT No.: PCT/JP2011/058122

§ 371 Date: Jan. 30, 2012

(30) Foreign Application Priority Data
Mar. 31, 2010 (JP) 2010-081769

(51) Int. Cl. G06Q 30/02

(52) U.S. Cl. 705/14.55

(57) ABSTRACT

While giving priority to a keyword designated by a seller, it is possible to reduce the extent of mismatch between the keyword designated by the seller and a keyword input as a search condition by a user. An advertisement main-search section (58) identifies, as a search result, at least one of purchase candidates corresponding to a main-keyword which is designated by the seller and fully or partially matches a search term word. In accordance with a number of the purchase candidate identified as the search result by the advertisement main-search section (58), an advertisement sub-search section (62) identifies purchase candidate corresponding to a sub-keyword which is identified based on an appearance frequency of a word contained in each piece of text data and fully or partially matches the search term word, and then adds the purchase candidate to the search result. An information output section (68) outputs information regarding the purchase candidate identified as the search result.

### TECHNICAL FIELD

The present invention relates to a search system, a search method, a search program, and a recording medium.

### BACKGROUND ART

In recent years, mail-order business using the Internet has become prevalent. In the mail-order business, there is generally used a search system which displays a list of products and services which satisfy a search condition designated by a user. One technology used in such a search system is a bid-based pay-per-click (PPC) advertising technology in which advertisements corresponding to the search condition designated by the user (generally referred to as listing advertisements) are displayed.

In the bid-based PPC advertising, when a plurality of advertisements are to be displayed, the order of listing of the advertisements is determined based, for example, on the cost-per-click (CPC) set by the seller of an advertised product, service, or the like. In the bid-based PPC advertising, the seller is charged based on the number of times the advertisement has been actually clicked, instead of the number of times the advertisement has been displayed.

As for the bid-based PPC advertising, for example, Patent Literature 1 describes the following method. That is, when an event occurrence condition designated in advance by an advertiser is satisfied, the corresponding advertisement is preferentially displayed, with the result that advertisement distribution is performed more appropriately based on ever-changing conditions, such as the click status and the trend, without requiring the advertiser to reset the keyword.

### PRIOR ART DOCUMENT

### Patent Document

[Patent Document 1] JP 2008-102174 A

### DISCLOSURE OF THE INVENTION

### Problems to be Solved by the Invention

When a keyword designated by a seller of a product, a service, or the like fully or partially matches the keyword which has been input as the search condition by a user, it is desired that the advertisement of that seller be displayed. However, in the case of the bid-based PPC advertising, users do not always use the exact keyword or the like designated by the seller when performing a search. If such a mismatch occurs between the keyword designated by the seller and the keyword input by the user as the search condition, the advertisement may not be displayed as expected by the seller or the user.

The present invention has been made in view of the above-mentioned problem, and an object thereof is to reduce the extent of mismatch between a keyword designated by a seller and a keyword input as a search condition by a user, while giving priority to the keyword designated by the seller.

### Means for Solving the Problems

In order to solve the above-mentioned problem, a search system of the present invention includes: main-keyword receiving means for receiving a main-keyword of a purchase candidate, which is designated by a seller of the purchase candidate, the purchase candidate being a candidate for a user to purchase; text data receiving means for receiving at least one piece of text data which is input regarding the purchase candidate by a user; sub-keyword identifying means for identifying a sub-keyword of the purchase candidate based on an appearance frequency of a word contained in each piece of text data regarding the purchase candidate; search term word receiving means for receiving a search term word from the user; main-search means for identifying, as a search result, at least one of purchase candidates corresponding to the main-keyword which fully or partially matches the search term word; sub-search means for, in accordance with a number of the purchase candidate identified as the search result by the main-search means, identifying a purchase candidate corresponding to a sub-keyword which fully or partially matches the search term word, and adding the purchase candidate to the search result; and information output means for outputting information regarding the purchase candidate identified as the search result.

Further, a search method of the present invention includes: a main-keyword receiving step of receiving a main-keyword of a purchase candidate, which is designated by a seller of the purchase candidate, the purchase candidate being a candidate for a user to purchase; a text data receiving step of receiving at least one piece of text data which is input regarding the purchase candidate by a user; a sub-keyword identifying step of identifying a sub-keyword of the purchase candidate based on an appearance frequency of a word contained in each piece of text data regarding the purchase candidate; a search term word receiving step of receiving a search term word from the user; a main-search step of identifying, as a search result, at least one of purchase candidates corresponding to the main-keyword which fully or partially matches the search term word; a sub-search step of, in accordance with a number of the purchase candidate identified as the search result in the main-search step, identifying a purchase candidate corresponding to a sub-keyword which fully or partially matches the search term word, and adding the purchase candidate to the search result; and an information output step of outputting information regarding the purchase candidate identified as the search result.

Further, a program of the present invention causes a computer to function as: main-keyword receiving means for receiving a main-keyword of a purchase candidate, which is designated by a seller of the purchase candidate, the purchase candidate being a candidate for a user to purchase; text data receiving means for receiving at least one piece of text data which is input regarding the purchase candidate by a user; sub-keyword identifying means for identifying a sub-keyword of the purchase candidate based on an appearance frequency of a word contained in each piece of text data regarding the purchase candidate; search term word receiving means for receiving a search term word from the user; main-search means for identifying, as a search result, at least one of purchase candidates corresponding to the main-keyword which fully or partially matches the search term word; sub-search means for, in accordance with a number of the purchase candidate identified as the search result by the main-search means, identifying a purchase candidate corresponding to a sub-keyword which fully or partially matches the search term word, and adding the purchase candidate to the search result; and information output means for outputting information regarding the purchase candidate identified as the search result.

Further, a recording medium of the present invention has a search program recorded thereon, the search program causing a computer to function as: main-keyword receiving means for receiving a main-keyword of a purchase candidate, which is designated by a seller of the purchase candidate, the purchase candidate being a candidate for a user to purchase; text data receiving means for receiving at least one piece of text data which is input regarding the purchase candidate by a user; sub-keyword identifying means for identifying a sub-keyword of the purchase candidate based on an appearance frequency of a word contained in each piece of text data regarding the purchase candidate; search term word receiving means for receiving a search term word from the user; main-search means for identifying, as a search result, at least one of purchase candidates corresponding to the main-keyword which fully or partially matches the search term word; sub-search means for, in accordance with a number of the purchase candidate identified as the search result by the main-search means, identifying a purchase candidate corresponding to a sub-keyword which fully or partially matches the search term word, and adding the purchase candidate to the search result; and information output means for outputting information regarding the purchase candidate identified as the search result.

According to the present invention, in accordance with the number of the purchase candidate identified as the search result through the search for the main-keyword designated by the seller, the search is performed for the sub-keyword identified from the text data input by the users, and the purchase candidate identified through the search for the sub-keyword is added to the search result. Therefore, the search result corresponding to the main-keyword designated by the seller is given priority over the search result corresponding to the sub-keyword identified from the text data input by the users. Further, according to the present invention, the search is performed for the sub-keyword identified from the text data input by the users, and hence even if the user uses, as the search condition, a feature of the purchase candidate which is not recognized by the seller, that purchase candidate may be identified as a result of the search for the sub-keyword. In this manner, according to the present invention, while giving priority to the keyword designated by the seller, it is possible to reduce the extent of mismatch between the keyword designated by the seller and the keyword input as the search condition by the user.

According to an aspect of the present invention, the main-search means identifies the purchase candidate as the search result with a predetermined number being an upper limit, and when the number of the purchase candidate identified as the search result by the main-search means is less than the predetermined number, the sub-search means identifies the purchase candidate corresponding to the sub-keyword which fully or partially matches the search term word, and adds the purchase candidate to the search result.

Further, according to an aspect of the present invention, the sub-keyword identifying means identifies a plurality of the sub-keywords, each of the plurality of the sub-keywords being associated with a rank corresponding to a number of a piece of the text data containing the each of the plurality of the sub-keywords, and until a total number of the purchase candidate identified as the search result reaches the predetermined number, the sub-search means repeats processing of identifying, in order from top, search candidate data containing a sub-keyword in a given rank which fully or partially matches the search term word, and adding the search candidate data to the search result.

Further, according to an aspect of the present invention, the search system further includes charging amount determining means for, when designation of the purchase candidate identified as the search result by the main-search means is received from the user, determining a charging amount for the seller of the purchase candidate.

Further, according to an aspect of the present invention, when the designation of the purchase candidate identified as the search result by the main-search means is received from the user, the charging amount determining means determines a bid price designated by the seller of the purchase candidate as the charging amount, and when designation of the purchase candidate identified as the search result by the sub-search means is received from the user, the charging amount determining means determines an amount of money, which is smaller than the bid price designated by the seller of the purchase candidate, as the charging amount.

Further, according to an aspect of the present invention, when the designation of the purchase candidate identified as the search result by the sub-search means is received from the user, the charging amount determining means determines the charging amount based on a bid price designated by such a seller that designates the sub-keyword corresponding to the purchase candidate as the main-keyword.

Further, according to an aspect of the present invention, when there are a plurality of the sellers who designate, as the main-keyword, the sub-keyword corresponding to the purchase candidate identified as the search result by the sub-search means, the charging amount determining means determines an amount of money, which is smaller than a smallest amount of money of the bid prices designated by the plurality of the sellers, as the charging amount.

Further, according to an aspect of the present invention, the search system further includes charging amount determining means for, when designation of the purchase candidate identified as the search result is received from the user, determining a charging amount for the seller of the purchase candidate based on a bid price designated by the seller of the purchase candidate, and, when designation of the purchase candidate identified as the search result by the sub-search means is received from the user, the charging amount determining means determines the charging amount so that an amount of money becomes higher as the rank of the sub-keyword is higher, based on the rank of the sub-keyword corresponding to the purchase candidate.

Further, according to an aspect of the present invention, the sub-keyword identifying means identifies, as the sub-keyword of the purchase candidate, a word different from the main-keyword of the purchase candidate.

Further, according to an aspect of the present invention, the main-keyword is associated with a bid price designated by an advertiser of the purchase candidate, and the information output means outputs information regarding the purchase candidate identified as the search result by the main-search means in accordance with the bid price associated therewith.

Further, according to an aspect of the present invention, the text data receiving means receives at least one piece of document data regarding the purchase candidate, which is created by a user, and the sub-keyword identifying means identifies the sub-keyword of the purchase candidate based on the appearance frequency of a word contained in each piece of document data regarding the purchase candidate.

### BRIEF DESCRIPTION OF THE DRAWINGS

FIG. 1 A diagram illustrating an example of a configuration of a search system according to an embodiment of the present invention.

FIG. 2 A diagram illustrating an example of a search condition input screen.

FIG. 3 A diagram illustrating an example of a search result screen.

FIG. 4 A diagram illustrating an example of a detailed product description screen.

FIG. 5 A diagram illustrating an example of a review list screen.

FIG. 6 A diagram illustrating an example of a review registration screen.

FIG. 7 A functional block diagram illustrating an example of functions implemented by a server according to the embodiment of the present invention.

FIG. 8 A diagram illustrating an example of product data.

FIG. 9 A diagram illustrating an example of advertiser data.

FIG. 10 A diagram illustrating an example of advertisement data.

FIG. 11 A diagram illustrating an example of review data.

FIG. 12 A diagram illustrating an example of a flow of advertisement data generation processing performed by the server according to the embodiment of the present invention.

FIG. 13 A diagram illustrating an example of a flow of search processing performed by the server according to the embodiment of the present invention.

FIG. 14 A diagram illustrating a modification example of a flow of the search processing performed by the server according to the embodiment of the present invention.

### MODE FOR CARRYING OUT THE INVENTION

Hereinbelow, an embodiment of the present invention is described in detail with reference to the drawings.

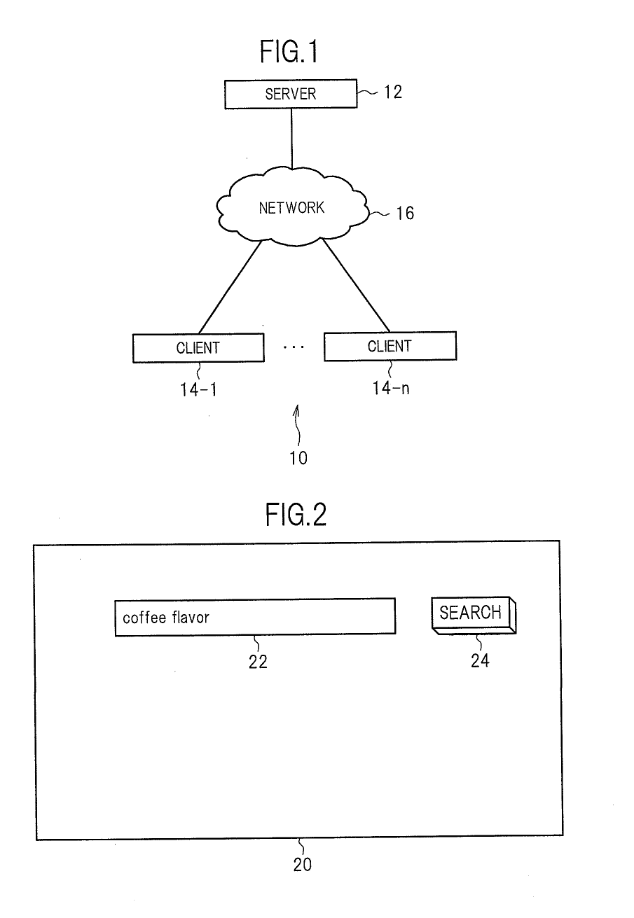

FIG. 1 is a diagram illustrating an example of a configuration of a search system 10 according to this embodiment. As illustrated in FIG. 1, the search system 10 according to this embodiment includes, for example, a server 12 and clients 14 (14-1 to 14-n). The server 12 and the clients 14 are connected to a network 16 such as the Internet, and are communicable to each other.

The server 12 includes, for example, a control unit being a program control device such as a CPU, which operates in accordance with a program installed on the server 12, a storage unit being a storage element such as a ROM or a RAM, a hard disk drive, or the like, and a communication unit being a communication interface such as a network board. Those components are connected to one another via a bus. The storage unit of the server 12 stores a program to be executed by the control unit of the server 12. Further, the storage unit of the server 12 operates also as a work memory of the server 12.

The client 14 consists of a known personal computer including, for example, a control device such as a CPU, a storage device being a storage element such as a ROM or a RAM, a hard disk drive, or the like, an output device such as a display, an input device such as a mouse or a keyboard, and a communication device such as a network board.

Here, an overview of the search system 10 according to this embodiment is described.

The search system 10 according to this embodiment is utilized, for example, as a module which builds a shopping site to be used for mail-order business utilizing the Internet.

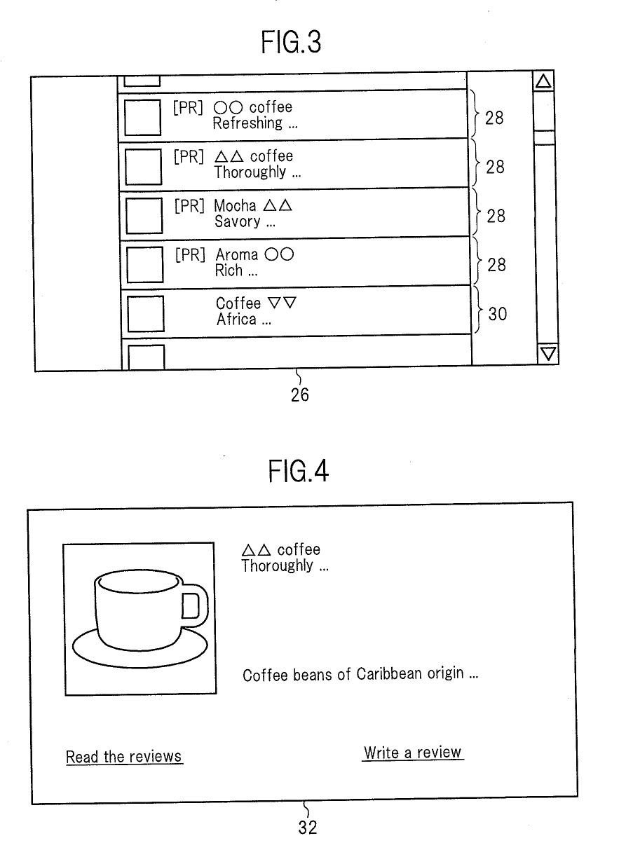

According to this embodiment, for example, a search condition input screen 20 exemplified in FIG. 2 is first showed on the display of the client 14. The search condition input screen 20 includes, for example, a search condition input field 22 and a search button 24. Then, when a user inputs words which serve as search conditions for identifying a product or a service which the user desires to purchase (search term words) in the search condition input field 22, and then clicks the search button 24, a search result screen 26 exemplified in FIG. 3 is showed on the display of the client 14.

The search result screen 26 exemplified in FIG. 3 contains at least one search result image. In this embodiment, for example, each search result image is any one of advertising information 28, which corresponds to listing advertisement, and at least one piece of normal search result information 30, which correspond to a normal search result. In the example of FIG. 3, the advertising information contains a character string of “[PR] ”. Further, in this embodiment, each search result image corresponds to a product or a service. In this embodiment, the user can scroll up and down the search result screen 26, and the search result screen 26 exemplified in FIG. 3 contains ten pieces of advertising information 28 in total.

Then, when the user clicks a search result image, the display of the client 14 displays a detailed product description screen 32 exemplified in FIG. 4 which shows a detailed description of a product corresponding to the selected search result image.

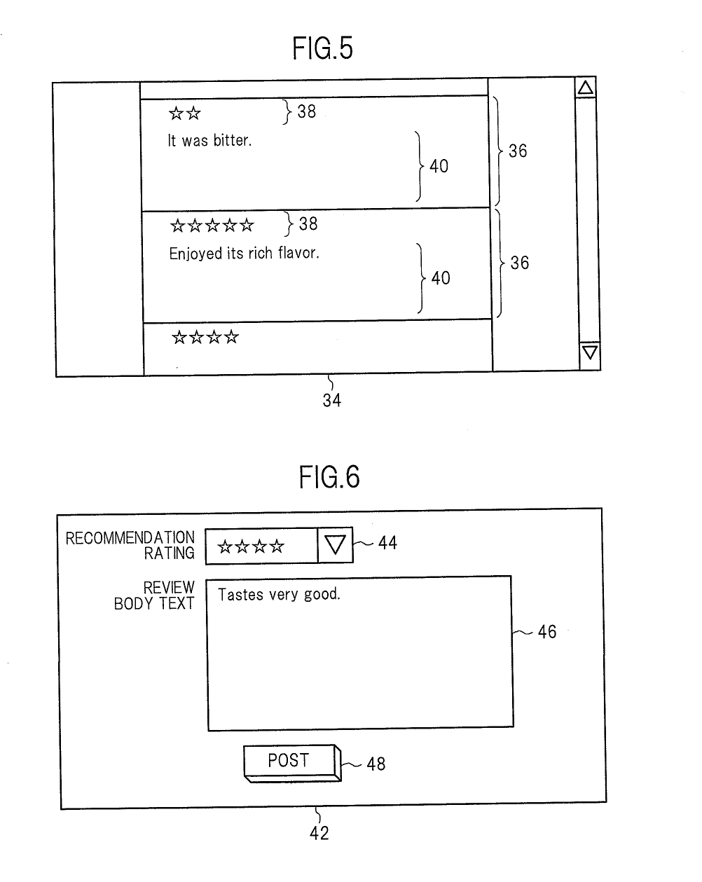

The detailed product description screen 32 exemplified in FIG. 4 contains a linked character string indicating “Read the reviews”, and a linked character string indicating “Write a review”. Here, when the user clicks the linked character string indicating “Read the reviews”, a review list screen 34 exemplified in FIG. 5 is displayed on the display of the client 14. The review list screen 34 contains pieces of review information 36 corresponding to reviews written by various users, including users who purchased the corresponding product or service and users who are contemplating purchasing the product. Each piece of the review information 36 contains an evaluation image 38 showing stars in accordance with the evaluation, a review body text character string 40 showing a review body text, and the like.

Further, in the detailed product description screen 32 illustrated in FIG. 4, when the user clicks the linked character string indicating “Write a review”, a review registration screen 42 exemplified in FIG. 6 is displayed on the display of the client 14. The review registration screen 42 contains an evaluation setting pull-down menu 44 for setting an evaluation on a product or a service on a scale of 1 to 5, a review body text input field 46 for inputting a review body text, and a registration button 48. When the user writes a review such as his/her comment on a product or a service, and clicks the registration button 48, the server 12 registers evaluation points, the review body text, and the like.

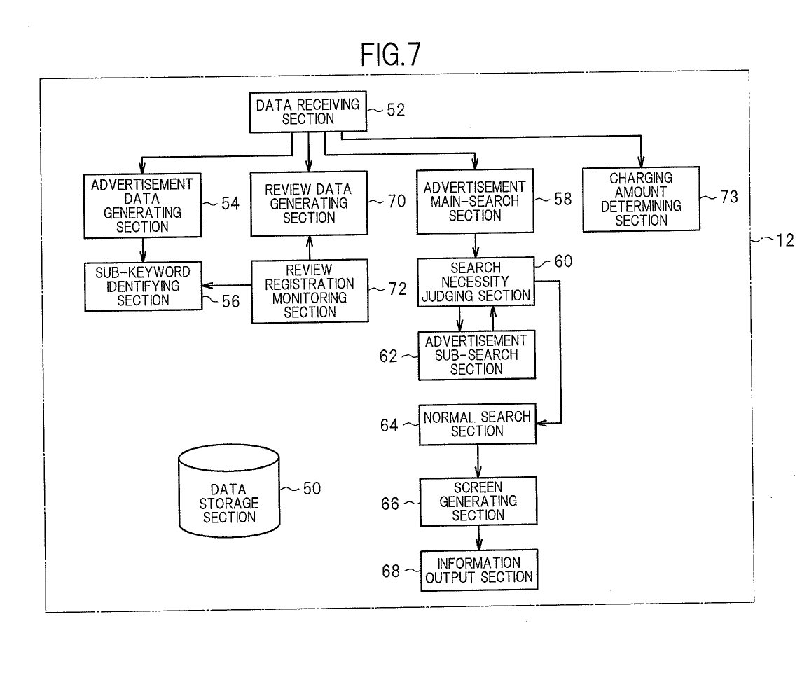

Here, description is given of functions implemented by the server 12 according to this embodiment. FIG. 7 is a functional block diagram illustrating an example of the functions implemented by the server 12 according to this embodiment.

As exemplified in FIG. 7, the server 12 includes a data storage section 50, a data receiving section 52, an advertisement data generating section 54, a sub-keyword identifying section 56, an advertisement main-search section 58, a search necessity judging section 60, an advertisement sub-search section 62, a normal search section 64, a screen generating section 66, an information output section 68, a review data generating section 70, a review registration monitoring section 72, and a charging amount determining section 73. The data storage section 50 is realized mainly by the storage unit of the server 12. The other elements are realized mainly by the control unit of the server 12.

Those elements are realized by executing a program installed in the server 12, which is a computer, by the control unit of the server 12. Note that, the program is supplied to the server 12 via, for example, a computer-readable information conveyance medium (recording medium) such as a CD-ROM or a DVD-ROM, or via a communication network such as the Internet.

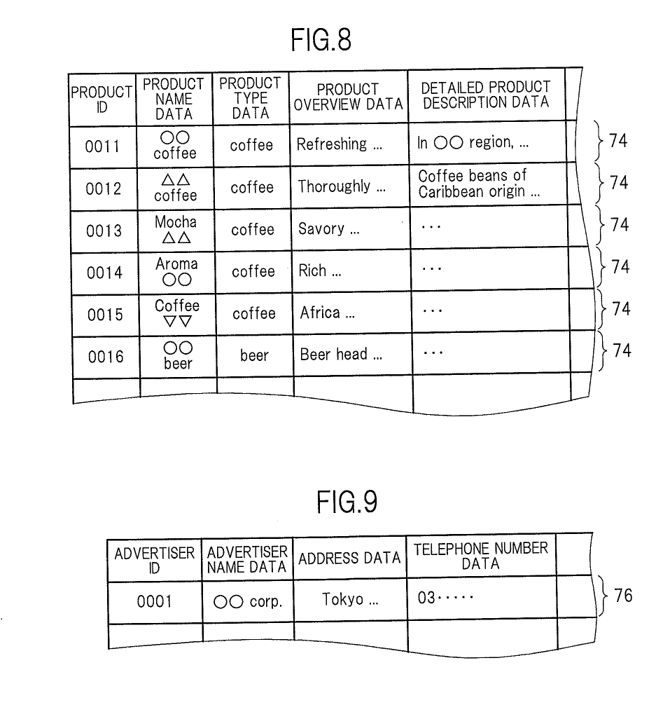

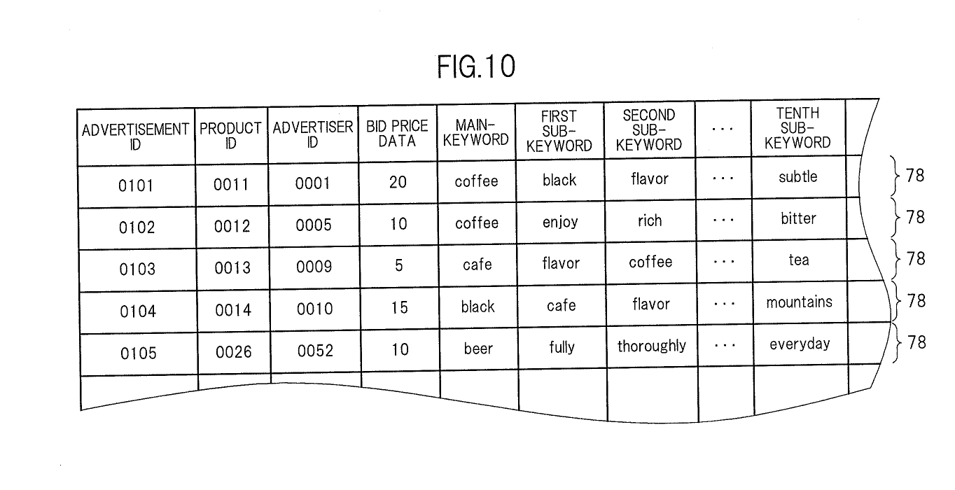

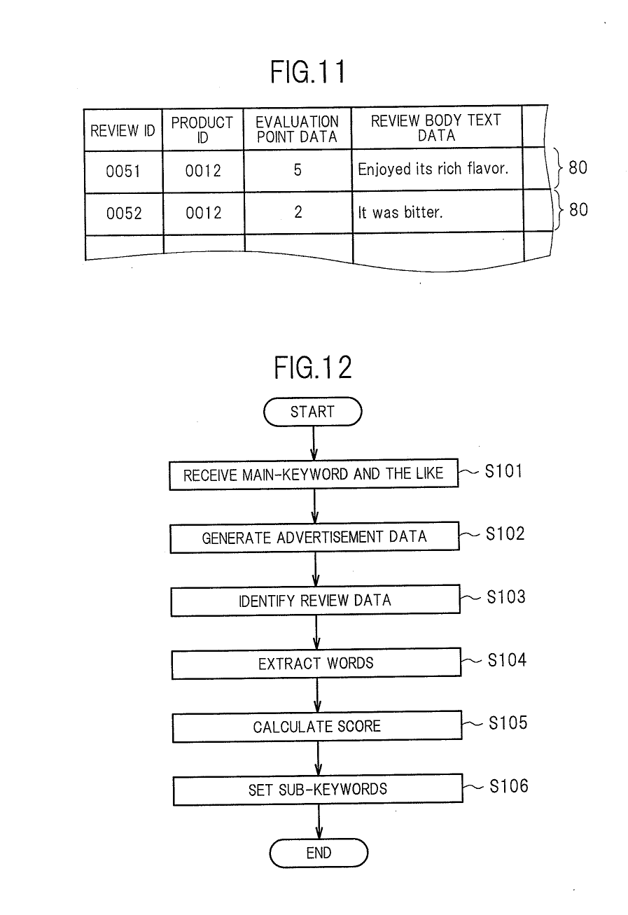

In this embodiment, the data storage section 50 stores, for example, product data 74 exemplified in FIG. 8, advertiser data 76 exemplified in FIG. 9, advertisement data 78 exemplified in FIG. 10, and review data 80 exemplified in FIG. 11.

The product data 74 is, for example, data corresponding to a product or a service offered for a user to purchase in a shopping site, and, as illustrated in FIG. 8, contains a product ID being the identifier of a product or a service, product name data indicating the name of a product or a service, product type data indicating the type of a product or a service, product overview data indicating the overview of a product or a service, detailed product description data indicating the contents of a detailed description on a product or a service, and the like. Further, the product data 74 is associated with a representative image being an image representing the corresponding product or service.

The advertiser data 76 is, for example, data on an advertiser being a provider (vendor, seller) or the like of a product or a service offered in the shopping site, and, as illustrated in FIG. 9, contains an advertiser ID being the identifier of an advertiser, advertiser name data indicating the name of an advertiser, address data indicating the address or the like of the head office of an advertiser, telephone number data indicating a main telephone number or the like of an advertiser, and the like.

The advertisement data 78 is, for example, data indicating settings related to the listing advertisement, and, as illustrated in FIG. 10, contains an advertisement ID being the identifier of an advertisement, the product ID of a product or a service to be advertised, the advertiser ID of an advertiser who desires publication on the listing advertisement, bid price data indicating a bid price for the listing advertisement, a main-keyword indicating a keyword designated by an advertiser, sub-keywords each indicating a keyword generated based on the review body text written by a user, and the like. Note that, in this embodiment, the advertisement data 78 contains one main-keyword and ten sub-keywords (first sub-keyword to tenth sub-keyword). Note that, the number of keywords to be contained in the advertisement data 78 is not limited thereto.

The review data 80 is, for example, data corresponding to the above-mentioned review, and, as illustrated in FIG. 11, contains a review ID being the identifier of the review data 80, the product ID of a product or a service whose review is written, evaluation point data indicating the points of an evaluation by the user on a product or a service on a scale of 1 to 5, review body text data being document data indicating a review body text, and the like.

Here, referring to a flow chart illustrated in FIG. 12, description is given of an example of advertisement data generation processing performed by the search system 10 according to this embodiment.

First, the data receiving section 52 receives the product ID, the advertiser ID, the bid price, the main-keyword, and the like, which are designated by the advertiser from the client 14 used by the advertiser (S101). Then, the advertisement data generating section 54 generates the advertisement data 78 based on those pieces of data (S102). At this stage, no value is assigned to the sub-keywords contained in the advertisement data 78.

Then, the sub-keyword identifying section 56 identifies, from among pieces of the review data 80 stored in the data storage section 50, the review data 80 containing the product ID contained in the advertisement data 78 generated through the processing of S102 (S103). Then, the sub-keyword identifying section 56 executes morphological analysis on the review body text data being the document data contained in each piece of the review data 80, to thereby extract words such as nouns and adjectives contained in each piece of the review body text data (S104). Then, the sub-keyword identifying section 56 calculates, for each word identified in the processing of S104, the number of pieces of the review body text data which contain that word to determine the score (S105). With this, it can be identified how many users have used a given word in their comments. In this example, the keyword is such a word as a noun or an adjective but may be any word as long as the keyword is a content word describing a product.

Then, the sub-keyword identifying section 56 identifies top ten high-scored words, and sets, in descending order from the top, those words as the first to tenth sub-keywords contained in the advertisement data 78 generated in the processing of S102 (S106). In this manner, the sub-keyword identifying section 56 identifies the sub-keywords of a product or a service offered for purchase, based on an appearance frequency of each word contained in the review body text data.

In this manner, the advertisement data 78 is generated. Further, in this embodiment, as described above, when new advertisement data 78 is registered, the review data 80 associated with the product ID is identified, and sub-keywords are extracted based on the review data 80.

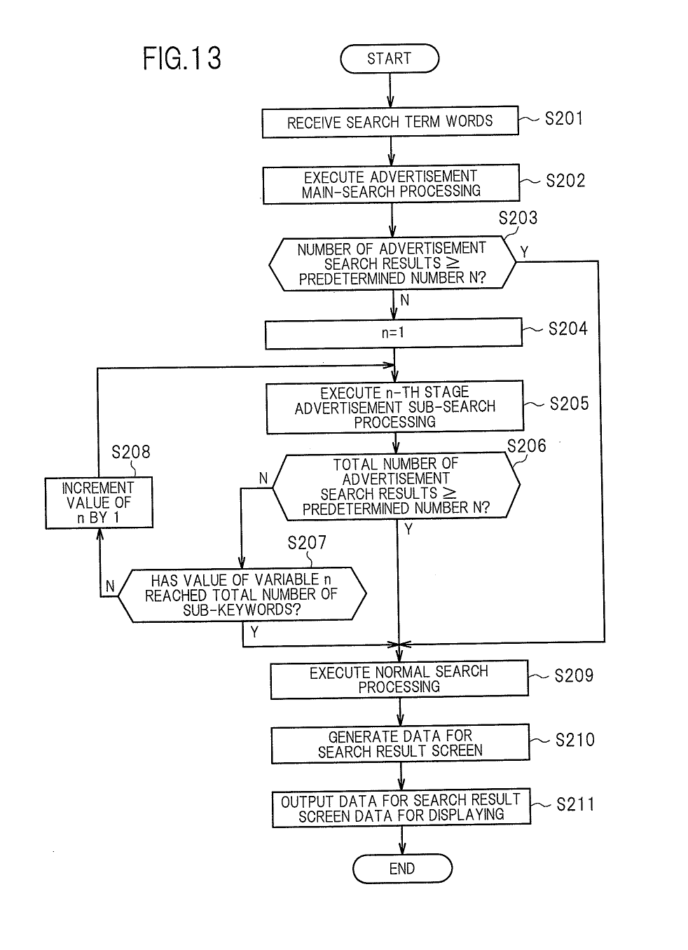

Next, referring to a flow chart of FIG. 13, description is given of an example of search processing performed by the search system 10 according to this embodiment.

In response to the click on the search button 24 on the search condition input screen 20 exemplified in FIG. 2, the client 14 transmits to the server 12 search term words which have been input in the search condition input field 22 by the user. Then, the data receiving section 52 receives the search term words (specifically, for example, “coffee” and “flavor”) (S201).

Then, the advertisement main-search section 58 executes advertisement main-search processing of identifying, as an advertisement search result, the product data 74 corresponding to the advertisement data 78 (specifically, for example, product data 74 whose product ID is the same as that of the advertisement data 78) containing a main-keyword which fully or partially matches the search term word (for example, fully or partially matches “coffee” or “flavor”) (S202). In this embodiment, the advertisement main-search section 58 identifies the product data 74 being the advertisement search result, for example, with a predetermined number N (in this processing example, for example, 10) being an upper limit. Under the condition that the number of pieces of the advertisement data 78 containing the main-keyword which fully or partially matches the search term word exceeds the predetermined number N, the advertisement main-search section 58 identifies the predetermined number N of pieces of the advertisement data 78 based, for example, on the amount of money indicated by the bid price data contained in the advertisement data 78 (for example, in descending order of the amount of money), and then identifies, as the advertisement search results, pieces of the product data 74 corresponding to those pieces of the advertisement data 78.

Then, the search necessity judging section 60 judges whether or not the number of pieces of the product data 74 identified as the advertisement search results in the processing of S202 is equal to or larger than the predetermined number N (in this processing example, for example, 10) (S203).

Under the condition that the number of pieces of the product data 74 is not equal to or larger than the predetermined number N (that is, less than the predetermined number N) (S203: N), the advertisement sub-search section 62 sets 1 as the value of a variable n (S204). Then, the advertisement sub-search section 62 executes n-th stage advertisement sub-search processing of adding, to the advertisement search results, the product data 74 corresponding to the advertisement data 78 containing an n-th sub-keyword which fully or partially matches the search term word received in the processing of S201 (for example, fully or partially matches “coffee” or “flavor”) (S205). As described above, in this embodiment, in accordance with, for example, the number of purchase candidates identified as search results by the advertisement main-search section 58, the advertisement sub-search section 62 identifies purchase candidates corresponding to the sub-keywords and adds the purchase candidates to the search results.

Then, the search necessity judging section 60 judges whether or not a total number of the advertisement search results is equal to or larger than the predetermined number N (S206). Under the condition that the total number of the advertisement search results is not equal to or larger than the predetermined number N (S206: N), the advertisement sub-search section 62 checks whether or not the value of the variable n has reached a total number of the sub-keywords (for example, 10) contained in the advertisement data 78 (S207). When the value of the variable n has not reached the total number of the sub-keywords (S207: N), the advertisement sub-search section 62 increments the value of the variable n by 1 (S208). Then, the processing returns to S205. As described above, in this processing example, the advertisement sub-search section repeats the processing of identifying, in order from the higher-ranked sub-keyword, search candidate data containing the sub-keyword which matches the search term word, and adding the identified search candidate data to the search results.

Under the condition that it is judged in the processing of S203 that the number of the advertisement search results is equal to or larger than the predetermined number N (S203: Y), under the condition that it is judged in the processing of S206 that the total number of the advertisement search results is equal to or larger than the predetermined number N (S206: Y), or under the condition that it is confirmed in the processing of S207 that the value of the variable n has reached the number of the sub-keywords contained in the advertisement data 78 (S207: Y), the normal search section 64 executes normal search processing of identifying, as a normal search result, the product data 74 having such words in the product name data, the product type data, the product overview data, or the detailed product description data that partially or fully match the search term word received in the processing of S201 (S209).

Then, the screen generating section 66 generates the data for the search result screen 26 containing the advertising information 28, which corresponds to the product data 74 identified as the advertisement search result, and the normal search result information 30, which corresponds to the product data 74 identified as the normal search result (S210).

In this processing example, the screen generating section 66 generates such data for the search result screen 26 that at least one piece of the advertising information 28 is arranged above at least one piece of the normal search result information 30. Further, in this processing example, the screen generating section 66 generates the data for the search result screen 26 in which pieces of the advertising information 28 are arranged in the following order from top to bottom: at least one piece of the advertising information 28 corresponding to the search result using the main-keyword (main group), at least one piece of the advertising information 28 corresponding to the search result using the first sub-keyword (first sub-group), at least one piece of the advertising information 28 corresponding to the search result using the second sub-keyword (second sub-group), . . . . Further, in this processing example, the screen generating section 66 generates the data for the search result screen 26 in which, for each group, pieces of the advertising information 28 are arranged from top to bottom in descending order of the bid prices associated therewith. Further, the advertising information 28 and the normal search result information 30 contained in the data for the search result screen 26 are each associated with the URL of the detailed product description screen 32 which shows a detailed description of the corresponding product or service.

Then, the information output section 68 outputs the data for the search result screen 26 generated in the processing of S210 to the display of the client 14 for displaying (S211). Then, the search processing of this processing example is finished.

Each of the advertising information 28 and the normal search result information 30 contained in the search result screen 26 contains the product name indicated by the product name data contained in the corresponding product data 74, text describing the overview of a product or a service indicated by the product overview data in the corresponding product data 74, the representative image associated with the corresponding product data 74, and the like.

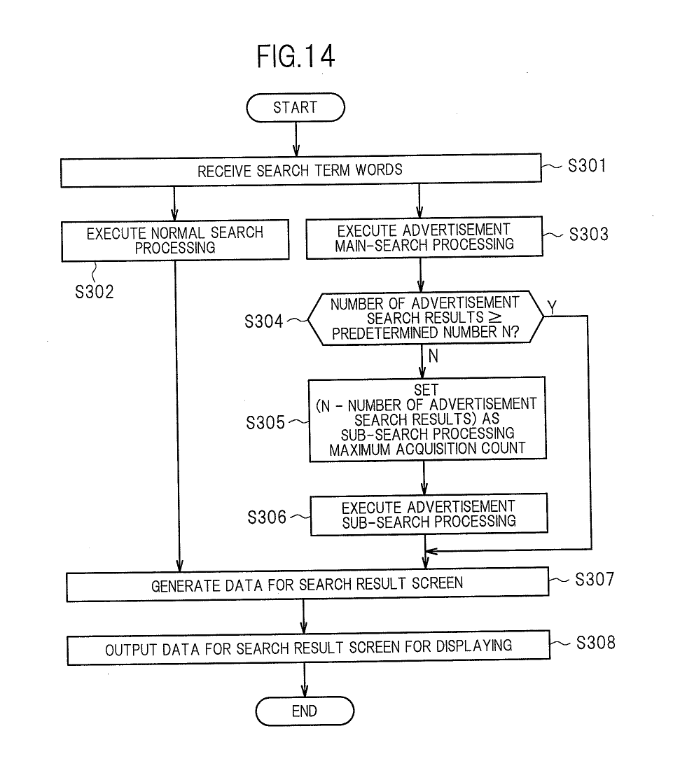

Note that, the processing example of the search processing is not limited to the above-mentioned processing of from S201 to S211. Hereinbelow, referring to a flowchart of FIG. 14, description is given of a modification example of the search processing performed by the search system 10 according to this embodiment.

First, similarly to the above-mentioned processing of S201, the data receiving section 52 receives search term words (S301). Then, similarly to the above-mentioned processing of S209, the normal search section 64 executes the normal search processing (S302). Further, in parallel to the processing of S302, similarly to the above-mentioned processing of S202, the advertisement main-search section 58 executes the advertisement main-search processing (S303). Then, similarly to the above-mentioned processing of S203, the search necessity judging section 60 judges whether or not the number of pieces of the product data 74 identified as the advertisement search results in the processing of S303 is equal to or larger than the predetermined number N (in this processing example, for example, 10) (S304). Under the condition that the number of pieces of the product data 74 is not equal to or larger than the predetermined number N (that is, less than the predetermined number N) (S304: N), the advertisement sub-search section 62 sets, as a sub-search processing maximum acquisition count, a value obtained by subtracting the number of pieces of the product data 74 identified as the advertisement search results in the processing of S303 from the above-mentioned predetermined number N (S305). Then, similarly to the above-mentioned processing of from S205 to 5208, the advertisement sub-search section 62 executes advertisement sub-search processing with the sub-search processing maximum acquisition count being the upper limit for the number of search results (S306).

Then, under the condition that it is judged in the processing of S304 that the number of the advertisement search results is equal to or larger than the predetermined number N (S304: Y) or under the condition that the processing of S306 is finished, similarly to the above-mentioned processing of S210, the screen generating section 66 generates the data for the search result screen 26 (S307). Then, similarly to the above-mentioned processing of S211, the information output section 68 transmits the data for the search result screen 26 generated in the processing of S307 to the client 14, and the client 14 shows the search result screen 26 on the display (S308). This enables executing, in parallel, the normal search processing and a series of advertisement search processing including the advertisement main-search processing and the advertisement sub-search processing, and hence it is expected to reduce a time period taken for the search result screen 26 to be showed on the display of the client 14 after starting the execution of the search processing.

As described above, when the user clicks the advertising information 28 or the normal search result information 30 contained in the search result screen 26, the client 14 transmits to the server 12 the URL of the detailed product description screen 32 associated with the clicked advertising information 28 or normal search result information 30. Then, the data receiving section 52 receives the URL. Then, the screen generating section 66 generates the data for the detailed product description screen 32 based on the received URL. Then, the information output section 68 transmits the data for the generated detailed product description screen 32 to the client 14. Then, when receiving the data for the detailed product description screen 32, the client 14 shows the detailed product description screen 32 on the display of the client 14. Note that, when the user clicks the advertising information 28 or the normal search result information 30 contained in the search result screen 26, the client 14 may transmit, to the server 12, the product ID corresponding to the clicked advertising information 28 or normal search result information 30, and the screen generating section 66 may generate the data for the detailed product description screen 32 based on the product ID.

The detailed product description screen 32 contains, for example, the representative image associated with the received product ID and the text indicated by the detailed product description data. Further, as described above, the detailed product description screen 32 contains the linked character string indicating “Read the reviews” and the linked character string indicating “Write a review”. Here, when the user clicks the linked character string indicating “Read the reviews”, the client 14 transmits a list output request for reviews corresponding to the product ID in question to the server 12. Then, the data receiving section 52 receives the list output request. Then, the screen generating section 66 identifies the review data 80 containing the product ID in question, and then generates the data for the review list screen 34 containing the review information 36 corresponding to each piece of the identified review data 80. Then, the information output section 68 outputs the data for the review list screen 34 for displaying on the display of the client 14. Each piece of the review information 36 contains the evaluation image 38 and the review body text character string 40. For example, the evaluation image 38 contained in the review information 36 corresponds to the points indicated by the evaluation point data, and the review body text character string 40 contained in the review information 36 corresponds to the review body text data.

When the user clicks the linked character string indicating “Write a review” on the detailed product description screen 32, the client 14 transmits an output request for the review registration screen 42 corresponding to the product ID in question to the server 12. Then, the data receiving section 52 receives the output request. Then, the screen generating section 66 generates the data for the review registration screen 42 associated with the product ID in question. Then, the information output section 68 outputs the review registration screen 42 for displaying on the display of the client 14.

As described above, the review registration screen 42 contains the evaluation setting pull-down menu 44, the review body text input field 46, and the registration button 48. Then, when the user sets the evaluation on a product or a service on the scale of 1 to 5 by using the evaluation setting pull-down menu 44, writes a review body text in the review body text input field 46, and clicks the registration button 48, the evaluation points set by using the evaluation setting pull-down menu 44, the review body text written in the review body text input field 46, and the product ID associated with the review registration screen 42 are transmitted to the server 12. Then, the data receiving section 52 receives those pieces of data.

Then, the review data generating section 70 generates the review data 80 containing a new review ID, the received product ID, the evaluation point data indicating the received evaluation points, and the review body text data indicating the received review body text, and then outputs the review data 80 to the data storage section 50.

In this embodiment, the review registration monitoring section 72 monitors the generation of the review data 80 performed by the review data generating section 70. Further, in this embodiment, for example, under the condition that detecting that new review data 80 has been generated, the review registration monitoring section 72 instructs the sub-keyword identifying section 56 to identify the review data 80 corresponding to the newly generated review data 80 regarding the contained product ID, and to update, through the same processing as the above-mentioned processing of from S103 to S106, the first to tenth sub-keywords contained in the advertisement data 78 containing the product ID in question. Then, the sub-keyword identifying section 56 updates the sub-keywords contained in the advertisement data 78.

Note that, in the search system 10 according to this embodiment, for example, when the user performs an order operation on the detailed product description screen 32, the user can order a product or a service shown on the detailed product description screen 32.

Further, in this embodiment, when the user clicks the advertising information 28 contained in the search result screen 26, the client 14 transmits the URL of the detailed product description screen 32 associated with the clicked advertising information 28 to the server 12. After the data receiving section 52 receives the URL, the charging amount determining section 73 identifies the product data 74 of the product or the service displayed on the detailed product description screen 32 being the link destination of the URL.

Then, the charging amount determining section 73 identifies the type of the keyword used when, in the above-mentioned search processing, the identified product data 74 was retrieved as the search result (whether the keyword is the main-keyword or the sub-keyword/in the case of the sub-keyword, in which rank the keyword is placed), and identifies the bid price data associated with that keyword in the advertisement data 78.

Then, for example, under the condition that the type of the keyword is the main-keyword, the charging amount determining section 73 determines the bid price indicated by the identified bid price data as a charging amount for the advertiser of the advertising information 28 clicked by the user (in this example, a charging amount for one click made by the user). Further, for example, under the condition that the type of the keyword is the sub-keyword, the charging amount determining section 73 determines, as the charging amount for the advertiser of the advertising information 28 clicked by the user, such an amount of money that is smaller than the bid price indicated by the identified bid price data and corresponds to the rank of the sub-keyword. Specifically, the charging amount determining section 73 calculates the charging amount in accordance with, for example, an equation of [(charging amount)=(bid price)×(10−rank)/10].

Note that, under the condition that the type of the keyword is the sub-keyword, the charging amount determining section 73 may determine the charging amount for the advertiser of the advertising information 28 clicked by the user, based on the bid price indicated by the bid price data contained in such advertisement data 78 that has the keyword in question set as the main-keyword and is of an advertiser different from the advertiser of the advertising information 28 clicked by the user. For example, when the search condition used in the above-mentioned search processing is “coffee”, and the advertising information 28 corresponding to a product ID of “0013” is clicked by the user, the charging amount determining section 73 may determine, as the charging amount for an advertiser whose advertiser ID is “0009”, such an amount of money that is smaller than the smallest (alternatively, average amount of money) of the bid prices indicated by the bid price data contained in two pieces of the advertisement data in which “coffee” is set as the main-keyword (the values of the advertisement IDs are “0101” and “0102”) (for example, 90%, ½, ⅓, or the like of the smallest amount of money or of the average amount of money).

Further, under the condition that the type of the keyword is the sub-keyword, the charging amount determining section 73 may avoid determining the charging amount, that is, avoid charging the advertiser of the advertising information 28 clicked by the user.

Further, under the condition that the type of the keyword is the sub-keyword, the charging amount determining section 73 may determine the charging amount in accordance with a representative value of the evaluation points indicated by the evaluation point data associated with the review body text data from which the sub-keyword in question has been extracted. For example, the charging amount may be calculated in accordance with an equation of [(charging amount)=(bid price indicated by identified bid price data)×(average value of evaluation points)/5]. Further, under the condition that the average value of the evaluation points associated with the review body text data from which the sub-keyword in question has been extracted is equal to or smaller than a predetermined value (for example, 2 or smaller), the charging amount determining section 73 may avoid determining the charging amount, that is, avoid charging the advertiser of the advertising information 28 clicked by the user.

Based, for example, on the charging amount determined in this manner, the server 12 generates charging information which is to be used for processing of charging the advertiser of the advertising information 28 clicked by the user. The charging information generated in this manner is used for, for example, such processing of charging the advertiser that is executed by the server 12 with the use of a known e-commerce technology. Then, eventually, for example, settlement processing is performed in which the determined charging amount is debited from the account of the advertiser of the advertising information 28 clicked by the user.

In the search system 10 according to this embodiment, in accordance with the number of purchase candidates identified as the search results of a search performed for the main-keyword designated by the advertiser, searches are performed for sub-keywords identified from the document data created by users, and purchase candidates identified through the searches for the sub-keywords are added to the search results. Thus, the search results obtained through a search for the main-keyword designated by the advertiser are given priority over the search results obtained through searches for the sub-keywords identified from the document data created by the user. Further, in the search system 10 according to this embodiment, for example, if such a feature that is not recognized by the advertiser (specifically, for example, “flavor”) has been extracted from the review information 36 and set as the sub-keyword, when the user performs a search with this feature set as the search condition, purchase candidates corresponding thereto are identified as the search results. Therefore, in the search system 10 according to this embodiment, even when a search is performed with such a search condition that is beyond assumption of the advertiser of a purchase candidate, that purchase candidate is expected to be displayed as the search result. This provides advantages to both the advertiser and the user.

Note that, the present invention is not limited to the above-mentioned embodiment.

For example, in the processing of S103 in the above-mentioned advertisement data generation processing, the sub-keyword identifying section 56 may identify the review data 80 whose evaluation points indicated by the evaluation point data are equal to or larger than a predetermined value (for example, 4 or larger) from among pieces of the review data 80 containing the product ID contained in the advertisement data 78 generated in the processing of S102. Then, in the processing of S104 in the above-mentioned advertisement data generation processing, the sub-keyword identifying section 56 may execute the morphological analysis on the review body text data contained in the review data 80 whose evaluation points are equal to or larger than the predetermined value, to thereby extract words contained in each piece of the review body text data. With this configuration, it is possible to prevent such words that are associated with low evaluations for the advertiser from being set as sub-keywords.

Further, for example, in the processing of S105 in the above-mentioned advertisement data generation processing, the sub-keyword identifying section 56 may calculate, as the score of a word, the product of the number of pieces of the review body text data containing the word identified in the processing of S104 and the average of the evaluation points indicated by pieces of the evaluation point data associated with the respective pieces of the review body text data. This reduces the possibility of such words that are associated with low evaluations for the advertiser being set as sub-keywords. Further, even if the words that are associated with low evaluations for the advertiser are set as sub-keywords, the possibility of those words being set as high-ranked sub-keywords is reduced.

Further, for example, in the processing of S105 in the above-mentioned advertisement data generation processing, the sub-keyword identifying section 56 may calculate, as the score of a word, the sum of weights calculated based on the evaluation point data associated with the respective pieces of the review body text data containing the word identified in the processing of S104. For example, the sub-keyword identifying section 56 may calculate the sum of weights as the score of a word in the following manner: under the condition that the value of the evaluation point data is 1 or 5, the above-mentioned weight for the corresponding review body text data is set to 3; under the condition that the value of the evaluation point data is 2 or 4, the above-mentioned weight for the corresponding review body text data is set to 2; and under the condition that the value of the evaluation point data is 3, the above-mentioned weight for the corresponding review body text data is set to 1. With this configuration, when sub-keywords are identified, words contained in reviews having an evaluation made by a user with strong feeling (extreme evaluation) are more likely to be set as the sub-keywords.

Further, for example, after the above-mentioned advertisement data generation processing is finished, the server 12 may provide the list of sub-keywords to the advertiser by e-mail or the like. Then, the advertisement sub-search section 62 may use only sub-keywords approved by the advertiser for the advertisement sub-search processing. With this configuration, it is possible to prevent in advance the product data 74 from being retrieved by a keyword which is undesirable for the advertiser. It is also possible to prevent in advance the advertiser from being charged even if the product data 74 have been retrieved by a keyword which is undesirable for the advertiser.

For example, the sub-keyword identifying section 56 may identify words different from the main-keyword contained in the advertisement data 78 as sub-keywords to be contained in this advertisement data 78. Specifically, for example, in the above-mentioned processing of S104, the sub-keyword identifying section 56 may identify words different from the main-keyword. Alternatively, in the above-mentioned processing of S105, the sub-keyword identifying section 56 may avoid calculating the score with regard to the main-keyword. Alternatively, in the above-mentioned processing of S106, the sub-keyword identifying section 56 may avoid setting the main-keyword as a sub-keyword. In this case, the sub-keyword identifying section 56 may move up the ranks of sub-keywords which are placed lower in rank than the main-keyword. Further, the sub-keyword identifying section 56 may set a word whose score is ranked at the eleventh place as the tenth sub-keyword.

Further, the sub-keyword identifying section 56 may execute processing of updating sub-keywords for all pieces of the review data at predetermined time intervals.

Further, the screen generating section 66 may identify a search result to be displayed in accordance with a given probability distribution of each search result, and generate the data for the search result screen 26 showing the identified search results.

Further, for example, when the data receiving section 52 has received the URL of the detailed product description screen 32 associated with the advertising information 28 or the normal search result information 30 in response to the click by the user on the advertising information 28 or the normal search result information 30 contained in the search result screen 26, in the above-mentioned search processing, the server 12 may cause the data storage section 50 to store, in association with the product ID of the product data 74 of a product or a service shown in the detailed product description screen 32, the search condition input by the user when the product data 74 in question was retrieved as the search result. Then, in the above-mentioned advertisement data generation processing, when setting sub-keywords to be contained in the generated advertisement data 78, the sub-keyword identifying section 56 may set, as the sub-keywords, words which are ranked high in the score calculated based on the appearance frequency of a word contained in the search condition stored in the data storage section 50 in association with the product ID contained in the advertisement data 78 in question. In this manner, the sub-keywords may be identified by using text data other than the document data such as the review body text data.

Further, the assignment of roles between the server 12 and the client 14 in the search system 10 is not limited to the above-mentioned embodiment. Further, the above-mentioned specific numerical values and character strings, and specific numerical values and character strings in the drawings are given by way of example, and the present invention is not limited to those numerical values and character strings.

1. A search system, comprising:
main-keyword receiving means for receiving a main-keyword of a purchase candidate, which is designated by a seller of the purchase candidate, the purchase candidate being a candidate for a user to purchase;
text data receiving means for receiving at least one piece of text data which is input regarding the purchase candidate by a user;
sub-keyword identifying means for identifying a sub-keyword of the purchase candidate based on an appearance frequency of a word contained in each piece of text data regarding the purchase candidate;
search term word receiving means for receiving a search term word from the user;
main-search means for identifying, as a search result, at least one of purchase candidates corresponding to the main-keyword which fully or partially matches the search term word;
sub-search means for, in accordance with a number of the purchase candidates identified as the search result by the main-search means, identifying a purchase candidates corresponding to a sub-keyword which fully or partially matches the search term word, and adding the purchase candidates to the search result; and
information output means for outputting information regarding the purchase candidates identified as the search result.

2. The search system according to claim 1,
wherein the main-search means identifies the purchase candidates as the search result with a predetermined number being an upper limit, and
wherein, when the number of the purchase candidates identified as the search result by the main-search means is less than the predetermined number, the sub-search means identifies the purchase candidates corresponding to the sub-keyword which fully or partially matches the search term word, and adds the purchase candidates to the search result.

3. The search system according to claim 2,
wherein the sub-keyword identifying means identifies a plurality of the sub-keywords, each of the plurality of the sub-keywords being associated with a rank corresponding to a number of a piece of the text data containing the each of the plurality of the sub-keywords, and
wherein, until a total number of the purchase candidates identified as the search result reaches the predetermined number, the sub-search means repeats processing of identifying, in order from top, search candidate data containing a sub-keyword in a given rank which fully or partially matches the search term word, and adding the search candidate data to the search result.

4. The search system according to claim 1, further comprising charging amount determining means for, when designation of the purchase candidate identified as the search result by the main-search means is received from the user, determining a charging amount for the seller of the purchase candidate.

5. The search system according to claim 4,
wherein, when the designation of the purchase candidate identified as the search result by the main-search means is received from the user, the charging amount determining means determines a bid price designated by the seller of the purchase candidate as the charging amount, and
wherein, when designation of the purchase candidate identified as the search result by the sub-search means is received from the user, the charging amount determining means determines an amount of money, which is smaller than the bid price designated by the seller of the purchase candidate, as the charging amount.

6. The search system according to claim 4, wherein, when the designation of the purchase candidate identified as the search result by the sub-search means is received from the user, the charging amount determining means determines the charging amount based on a bid price designated by such a seller that designates the sub-keyword corresponding to the purchase candidate as the main-keyword.

7. The search system according to claim 6, wherein, when there are a plurality of the sellers who designate, as the main-keyword, the sub-keyword corresponding to the purchase candidate identified as the search result by the sub-search means, the charging amount determining means determines an amount of money, which is smaller than a smallest amount of money of the bid prices designated by the plurality of the sellers, as the charging amount.

8. The search system according to claim 3, further comprising charging amount determining means for, when designation of the purchase candidate identified as the search result is received from the user, determining a charging amount for the seller of the purchase candidate based on a bid price designated by the seller of the purchase candidate,
wherein, when designation of the purchase candidate identified as the search result by the sub-search means is received from the user, the charging amount determining means determines the charging amount so that an amount of money becomes higher as the rank of the sub-keyword is higher, based on the rank of the sub-keyword corresponding to the purchase candidate.

9. The search system according to claim 1, wherein the sub-keyword identifying means identifies, as the sub-keyword of the purchase candidate, a word different from the main-keyword of the purchase candidate.

10. The search system according to claim 1,
wherein the main-keyword is associated with a bid price designated by a seller of the purchase candidate, and
wherein the information output means outputs information regarding the purchase candidate identified as the search result by the main-search means in accordance with the bid price associated therewith.

11. The search system according to claim 1,
wherein the text data receiving means receives at least one piece of document data regarding the purchase candidate, which is created by a user, and
wherein the sub-keyword identifying means identifies the sub-keyword of the purchase candidate based on the appearance frequency of a word contained in each piece of document data regarding the purchase candidate.

12. A search method, comprising:
a main-keyword receiving step of receiving a main-keyword of a purchase candidate, which is designated by a seller of the purchase candidate, the purchase candidate being a candidate for a user to purchase;
a text data receiving step of receiving at least one piece of text data which is input regarding the purchase candidate by a user;
a sub-keyword identifying step of identifying a sub-keyword of the purchase candidate based on an appearance frequency of a word contained in each piece of text data regarding the purchase candidate;
a search term word receiving step of receiving a search term word from the user;
a main-search step of identifying, as a search result, at least one of purchase candidates corresponding to the main-keyword which fully or partially matches the search term word;
a sub-search step of, in accordance with a number of the purchase candidates identified as the search result in the main-search step, identifying a purchase candidates corresponding to a sub-keyword which fully or partially matches the search term word, and adding the purchase candidates to the search result; and
an information output step of outputting information regarding the purchase candidates identified as the search result.

13. (canceled)

14. A non-transitory recording medium having a search program recorded thereon, the search program causing a computer to function as:
main-keyword receiving means for receiving a main-keyword of a purchase candidate, which is designated by a seller of the purchase candidate, the purchase candidate being a candidate for a user to purchase;
text data receiving means for receiving at least one piece of text data which is input regarding the purchase candidate by a user;
sub-keyword identifying means for identifying a sub-keyword of the purchase candidate based on an appearance frequency of a word contained in each piece of text data regarding the purchase candidate;
search term word receiving means for receiving a search term word from the user;
main-search means for identifying, as a search result, at least one of purchase candidates corresponding to the main-keyword which fully or partially matches the search term word;
sub-search means for, in accordance with a number of the purchase candidates identified as the search result by the main-search means, identifying a purchase candidates corresponding to a sub-keyword which fully or partially matches the search term word, and adding the purchase candidates to the search result; and
information output means for outputting information regarding the purchase candidates identified as the search result.
